(19) United States
(12) Patent Application Publication
(10) Pub. No.: US 2026/0214769 A1
(43) Pub. Date: Jul. 23, 2026

(54) HIGH LPW EFFICIENCY COB AND LIGHT ENGINE INCLUDING THE SAME

(71) Applicant: ERP POWER, LLC, Westlake Village, CA (US)

(72) Inventors: Michael Archer, Moorpark, CA (US); James H. Mohan, Valencia, CA (US); Louis Chen, Simi Valley, CA (US)

(21) Appl. No.: 19/457,143

(22) Filed: Jan. 22, 2026

Related U.S. Application Data
(60) Provisional application No. 63/748,400, filed on Jan. 22, 2025.

(51) Int. Cl. H05B 45/54; H05B 45/38

(52) U.S. Cl. CPC H05B 45/54; H05B 45/38

(57) ABSTRACT

A high-lumens-per-watt (LPW) efficiency light engine includes a power supply configured to receive an AC input signal and to generate a rectified signal; a light driver configured to generate a drive signal based on the rectified signal, the drive signal having a voltage of about 100 V to about 485 V; a light source including a high-voltage chip-on-board (COB) light configured to emit light based on the drive signal, the high-voltage chip-on-board (COB) light including a first power terminal, a second power terminal, and a plurality of LED chips coupled between the first and second power terminals, the drive signal being applied across the first and second power terminals; and a housing configured to encapsulate the power supply, the light driver, and the light source and to provide electromagnetic interference (EMI) shielding of circuitry of the light engine from the outside.

### CROSS-REFERENCE TO RELATED APPLICATION(S)

This application claims priority to, and the benefit of, U.S. Provisional Application No. 63/748,400 (“HIGH LPW EFFICIENCY COB AND LIGHT ENGINE INCLUDING THE SAME”), filed on Jan. 22, 2025, the entire content of which is incorporated herein by reference.

This application is also related to U.S. patent application Ser. No. 18/934,026 (“TUNABLE COLOR LIGHT ENGINE HAVING MODULAR AND INTERCHANGEABLE DESIGN”), filed on Oct. 31, 2024, which claims priority to, and the benefit of, U.S. Provisional Application No. 63/594,935 (“TUNABLE COLOR LIGHT ENGINE HAVING MODULAR AND INTERCHANGEABLE DESIGN”), filed on Oct. 31, 2023; U.S. Provisional Application No. 63/594,937 (“WHITE COLOR LIGHT ENGINE HAVING MODULAR AND INTERCHANGEABLE DESIGN”), filed on Oct. 31, 2023; and U.S. Provisional Application No. 63/594,940 (“ADJUSTABLE WHITE LIGHT ENGINE HAVING MODULAR AND INTERCHANGEABLE”), filed on Oct. 31, 2023, the entire contents of which are incorporated herein by reference.

### FIELD

Aspects of the present invention are related to lighting systems.

### BACKGROUND

In the field of lighting systems, particularly those utilizing light emitting diode (LED) technology, there has been a persistent challenge in achieving higher lumens per watt (LPW) efficiency while maintaining safety and cost-effectiveness. Traditional LED designs are typically configured for low-voltage operation, often around 36 volts, to ensure compatibility with existing fixtures and to avoid safety issues associated with high voltage. This low-voltage design necessitates higher current, which in turn requires larger emitters and limits the number of LEDs that can be integrated into a given size, thereby constraining the LPW efficiency.

Existing solutions often involve separate components for the LED and the power supply, lacking integration that could optimize performance. High-voltage LED arrays are used in some applications, such as streetlamps, but these are generally large and composed of many discrete LEDs, making them unsuitable for more compact applications. Furthermore, the safety concerns associated with high-voltage systems, such as shock hazards, have deterred manufacturers from pursuing integrated high-voltage solutions. As the demand for more efficient lighting systems grows, there is a need for innovative approaches that can overcome these limitations, providing higher LPW efficiency without compromising safety or increasing costs.

The above information disclosed in this Background section is only for enhancement of understanding of the invention, and therefore it may contain information that does not form the prior art that is already known to a person of ordinary skill in the art.

### SUMMARY

Aspects of embodiments of the present invention are directed to a high-voltage, high-efficiency COB light source and a light engine with high lumens-per-watt (LPW) efficiency including the same. The light engine satisfies the demand for more efficient lighting systems by providing higher LPW efficiency without compromising safety or increasing costs.

According to some embodiments of the present disclosure, there is provided a high-lumens-per-watt (LPW) efficiency light engine including: a rectifier configured to receive an AC input signal and to generate a rectified signal; a light driver configured to generate a drive signal based on the rectified signal, the drive signal having a voltage of about 100 V to about 485 V; a light source including a high-voltage chip-on-board (COB) light configured to emit light based on the drive signal, the high-voltage chip-on-board (COB) light including a first power terminal, a second power terminal, and a plurality of LED chips coupled between the first and second power terminals, the drive signal being applied across the first and second power terminals; and a housing configured to encapsulate the power supply, the light driver, and the light source and to provide electromagnetic interference (EMI) shielding of circuitry of the light engine from the outside.

In some embodiments, the drive signal has a current of about 15 mA to about 45 mA for under-driving the plurality of LED chips.

In some embodiments, each one of the plurality of LED chips is electrically connected in series with other ones of the plurality of LED chips between the first and second power terminals.

In some embodiments, the plurality of LED chips includes LED chip stacks that are electrically coupled in series with one another between the first and second power terminals, each one of the LED chip stacks includes a first LED chip string and a second LED chip string, the first and second LED chip strings being connected in parallel, and each one of the first and LED chip strings includes a subset of series-connected LED chips.

In some embodiments, the plurality of LED chips are arranged along columns on a substrate of the high-voltage chip-on-board (COB) light, and a first column of the LED chips are arranged along a first column and are sequentially connected in series, a first LED chip of the first column of the LED chips being connected to the first power terminal, and a last LED chip of the first column of the LED chips being electrically connected in series with a first LED chip of an adjacent column of LED chips.

In some embodiments, the plurality of LED chips are arranged along columns on a substrate of the high-voltage chip-on-board (COB) light, and a first column of the LED chips are arranged along a first column and are sequentially connected in series, and a second column of the LED chips are arranged along a second column and are sequentially connected in series, and a first LED chip of the first column of the LED chips, a first LED chip of the second column of the LED chips, and the second LED chip of the fist column of the LED chips are sequentially connected in series.

In some embodiments, a LPW of the high LPW efficiency light engine is about 190 to about 210 for lumens output of about 905 to about 2900.

In some embodiments, the light driver includes a boost converter configured to boost the rectified signal to a level of the drive signal.

### BRIEF DESCRIPTION OF THE DRAWINGS

The accompanying drawings, together with the specification, illustrate example embodiments of the present disclosure, and, together with the description, serve to explain the principles of the present disclosure.

FIG. 1A illustrates a perspective view of a light engine with high LPW efficiency including a high-efficiency COB, according to some example embodiments of the present disclosure.

FIG. 1B illustrates the light driver and the high-efficiency COB of the light engine of FIG. 1A, according to some example embodiments of the present disclosure.

FIG. 1C illustrates a schematic diagram of the lighting engine, according to some example embodiments of the present disclosure.

FIGS. 2A and 2B illustrate various configurations of the high-efficiency COB, according to some example embodiments of the present disclosure.

FIGS. 3A, 3B, and 3C illustrate various configurations of the high-efficiency COB, according to some example embodiments of the present disclosure.

FIG. 4 is a graph illustrating the LPW efficiency of the light engine relative to that of the lighting systems of the related art, according to some embodiments of the present disclosure.

### DETAILED DESCRIPTION

The detailed description set forth below is intended as a description of example embodiments of a compact, integrated multi-layered lighting system, provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

In the field of lighting systems utilizing LED technology, achieving higher lumens per watt (LPW) efficiency while maintaining safety and cost-effectiveness has been a persistent challenge. Traditional LED designs are typically configured for low-voltage operation (e.g., about 36 volts) to ensure compatibility with existing fixtures and avoid high-voltage safety issues. This low-voltage design requires higher current, necessitating larger emitters and limiting the number of LEDs that can be integrated into a given size, thereby constraining LPW efficiency. Additionally, the lack of integration between LED components and power supply systems often results in suboptimal performance. Existing solutions, such as high-voltage LED arrays used in streetlamps, are generally large and composed of many discrete LEDs, making them unsuitable for compact applications. Safety concerns associated with high-voltage systems, such as shock hazards, have further deterred manufacturers from pursuing integrated high-voltage solutions.

The approach of the present disclosure addresses these challenges by introducing a high-voltage chip-on-board (COB) light source integrated within a compact light engine. According to some embodiments, the high-voltage COB is restructured to increase the number of light emitters (e.g., LEDs) while reducing current density, thereby enhancing LPW efficiency. By configuring the COB in a series arrangement, the design achieves higher operating voltages, which allows for a lower drive current and a more efficient power transfer. The integration of the COB with the power supply within a single engine enclosure not only optimizes performance but also ensures safety by housing high-voltage components in a certified enclosure. This design obsoletes existing COB configurations and sets a new standard for high-efficiency lighting systems.

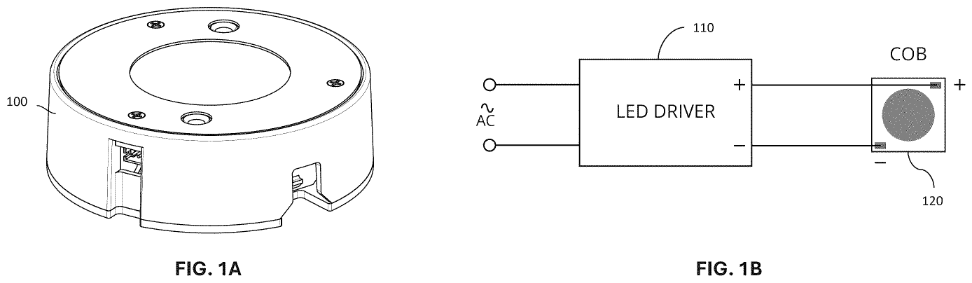

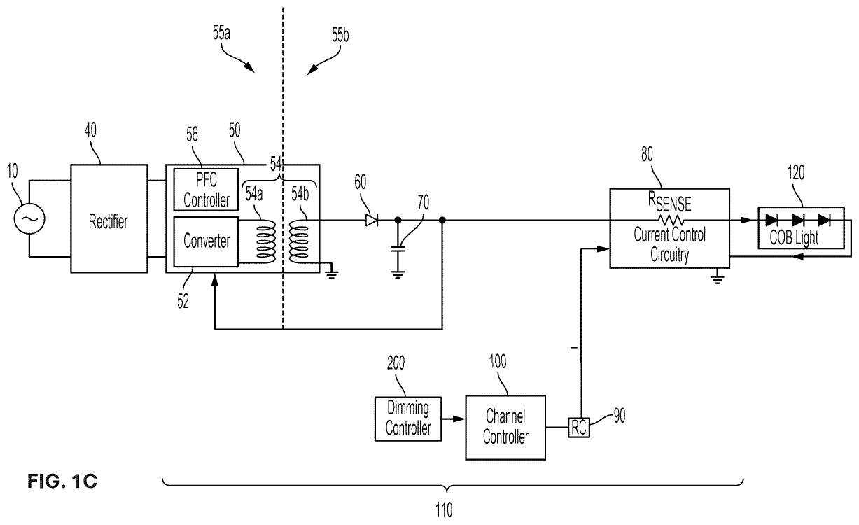

FIG. 1A illustrates a perspective view of a light engine 100 with high LPW efficiency including a high-voltage COB, according to some example embodiments of the present disclosure. FIG. 1B illustrates the light driver 110 and the high-voltage COB 120 of the light engine of FIG. 1A, according to some example embodiments of the present disclosure.

The light engine 100 is a self-contained lighting system whose only connection to the outside world is through the two AC input lines, and, in some examples, lead wires connected to a programming device that is configured to program various aspects of the light engine (e.g., CCT, dimming level, etc.). The light engine 100 includes a light driver 110 and a light source 120 in one compact package, which may have a round aperture. The light driver 110 may have an integrated power supply that converts the input AC signal to a DC signal for driving the light source 120 to produce any desired light output color and any light intensity (e.g., 3k or 4k lumen).

The input to the light engine 100 is an AC signal that may be provided by a neutral line and one power line from the wall (i.e., no ground line). The lighting engine 100 may receive AC input from about 90 VAC to about 305 VAC (which is considered to be a high voltage). The light engine 100 performs the voltage conversion (AC-DC), and produces the desired light output. This is in contrast to the related art in which the light engines input DC voltages and rely on external power supplies that convert wall AC into a DC voltage. By incorporating the AC-DC voltage converting power supply into the same package as the light driver, the light engine 100 eliminates the need for an additional power supply, which saves cost and simplifies installation. However, as a result of this integration, the light engine 100 addresses and resolves significant issues related to high voltages requirements, powerline quality requirements, thermal concerns, and insulation requirements, which the related art need not be concerned with nor address.

The light engine 100 includes a certified enclosure constructed from materials that enhance thermal dissipation and Electromagnetic Interference Shielding (EMI) shielding, ensuring safety and reliability in various environmental conditions. In some examples, the light engine 100 strategically employs insulation to avoid arcing between components, which could otherwise damage or destroy such components and to make the unit safe to touch by a user. This allows the light engine 100 to satisfy mandatory safety requirements related to insulation. Additionally, because the light engine 100 directly connects to wall AC, it is capable of satisfying stringent EMI requirements (such as class B and FCC/worldwide requirements related to radiative emissions) that include not injecting noise on, and not adding extra harmonics or distortions to, the AC input lines, and limiting radiative noise outside of the lighting system packaging/can.

According to some embodiments, the light source 120 includes a high-voltage and high-efficiency chip on board (COB) light that includes a panel of tightly packed LEDs (i.e., high density of LEDs in a small area) and is capable of emitting a powerful and consistent/uniform beam (e.g., conical beam) of light. While not shown in FIG. 1A, the light engine 100 may include advanced optical components, such as a total internal reflection (TIR) lens, which is integrated with the light engine 100 to maximize optical efficiency and light distribution.

FIG. 1C illustrates a schematic diagram of the lighting engine 100, according to some example embodiments of the present disclosure.

According to some embodiments, the lighting engine 100 includes an input source 10, a COB light 120, and a light driver 110 for powering and controlling the brightness/intensity of the COB light 120.

The input source 10 may include an alternating current (AC) power source that may operate at a voltage of 100 Vac, a 120 Vac, a 240 Vac, 277 Vac, or higher, for example. The input source 10 may also include a dimmer electrically powered by said AC power sources. The dimmer may modify (e.g., cut/chop a portion of) the input AC signal according to a dimmer level before sending it to the light driver 30, and thus variably reduces the electrical power delivered to the light driver 30 and the COB light 120. In some examples, the dimmer may be a TRIAC or ELV dimmer, and may chop the front end or leading edge of the AC input signal. According to some examples, the dimmer interface may be a rocker interface, a tap interface, a slide interface, a rotary interface, or the like.

In some embodiments, the light driver 110 includes an input rectifier (e.g., an input rectifier circuit) 40, a power supply (also referred to as a power supply circuit) 50, an output rectifier 60, a filter 70, a current control circuit 80, and a channel controller 100.

The input rectifier 40 may provide the same polarity of output for either polarity of the AC signal from the input source 10. In some examples, the input rectifier 40 may include a full-wave circuit using a center-tapped transformer, a full-wave bridge circuit with four diodes, a half-wave bridge circuit, or a multi-phase rectifier. The input AC signal may be about 90 VAC to about 305 VAC at 50-60 Hz.

The power supply circuit 50 converts the rectified AC signal generated by the input rectifier 40 into a drive signal for powering the COB light 120. In some embodiments, the power supply circuit 50 includes a voltage converter 52 for maintaining (or attempting to maintain) a constant DC bus voltage on its output while drawing a current that is in phase with and at the same frequency as the line voltage (by virtue of a PFC controller/circuit 56). A transformer 54 inside the power supply circuit 50 produces the desired output voltage from the DC bus. In some examples, the power supply circuit 50 may include the PFC circuit (or PFC controller) 56 for improving (e.g., increasing) the power factor of the load on the input source 10 and reducing the total harmonic distortions (THD) of the light driver 30.

According to some embodiments, the output rectifier (e.g., diode) 60 and filter (e.g., capacitor) 70 convert the AC driving signal output by the secondary winding 54a of the transformer 54 into a DC channel current for driving the COB light 120. The anode of the output rectifier 60 may be connected (e.g., directly connected) to the output terminal of the power supply circuit 50.

According to some embodiments, the current control circuit 80 is configured to adjust the current of the COB light 120 based on the drive signal from the power supply circuit 50 and a corresponding filtered reference signal (e.g., a pulse width modulated (PWM) signal) from the channel controller 100 and the filter circuit 90. By controlling the color intensity (as measured by lumens, Lm) of the COB light 120, the channel controller 100 may enable light dimming.

The dimmer level may be determined based on a dimmer setting from a dimming controller 200, which may be in electrical communication with the channel controller 100, as shown in FIG. 1C. However, embodiments of the present disclosure are not limited thereto. For example, the dimming controller 200 may also be a TRIAC or ELV dimmer at the input source 10. In some examples, the dimmer level at 100% may correspond to an output light intensity of about 5000 lumens.

An important consideration when selecting a light source is its lumens-per-watt (LPW) efficiency, which is a measure of how efficient the light source is at producing visible light. Over the years, this value for light fixtures has steadily increased as LED lights have gradually replaced their predecessor halogen or incandescent lamps in most applications. Currently, the COB lights of the related art generally exhibit LPWs of around 75 to 100. However, this efficiency can be further improved as described below.

The COB light is fundamentally made up of an LED design which is repeated over and over again until the COB runs out of room for more LEDs. The connection of the LEDs in the design can be manipulated by the connecting links. The bigger the COB size the more LEDs can fit for any emitter design. COB sizes have been standardized, so getting the LED count up will drive the LPW up because the current density regardless of the series parallel configuration will drive LPW.

Current COB lights are generally designed for relatively low voltage operation, the most common being 36 V. This allows for easy mounting of the LED to its fixture without running into safety/UL issues that have to do with high voltages. However, the lower voltage means that the power supply must supply higher current to fully excite the LEDs and means that the COB must have the individual emitter (i.e., LED) design set to handle the high currents. This affects the individual LED design size and thus the total number of LEDs that can fit inside each size COB. The COBs have a plurality of parallel strings of LEDs, each composed of a number of series-connected LEDs, connected internally to keep the stack voltage at the target (e.g., 36 volts).

LPW efficiency is first and foremost affected by current density in the LED itself, which may be defined as the amount of current per unit area of an LED (which essentially represents how concentrated the current is across the LED's active area). One way to increase the LPW on an existing LED design at a particular voltage is to underdrive the LED. For example, instead of driving the LED at 500 mA of current, driving at half of that current will increase LPW substantially. However, this will also reduce the total lumens output by the LED.

According to some embodiments, the high-efficiency COB light addresses the LPW issue in a number of ways that will be described further below.

In some embodiments, the LEDS of the COB light are all electrically connected together in series, in contrast to the COBs of the related art that include both series and parallel stacks of LEDs. The series connection drives the stack voltage high (e.g., to 360 V or 450 V, versus a more typical 36 V) and simultaneously drives down the drive current, which allows for design of a single stage light engine that has operating efficiencies of about 92% to 95.5% (e.g., about 94%) with a simplified internal structure that is denser and lower cost than a lower voltage, higher LPW light engine.

Because the output wires to the LED are entirely contained within the sealed enclosure of the light engine housing, the light engine qualifies for UL SREC (Safety Related Electronic Control) certification, which certifies that the light engine unit is self-contained, self-certified essentially as a drop in fixture, safe to touch (electrically and thermally), and cannot harm an installer.

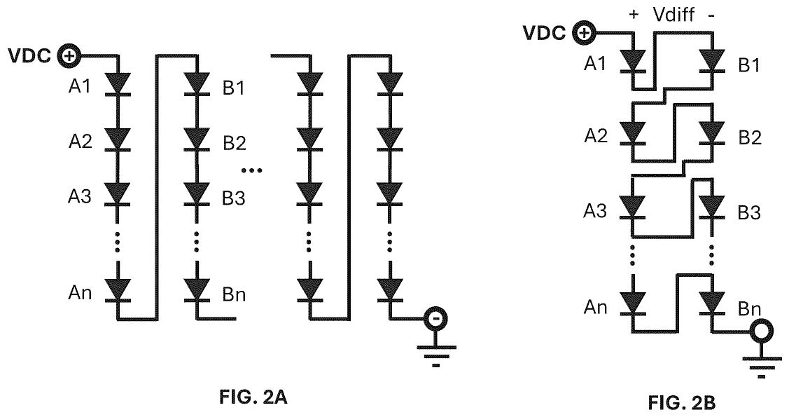

FIG. 2A illustrates an example of a series-connected string of LEDs, in which columns of n LEDs (that would otherwise be coupled in parallel in the related art) are strung together end to end, according to some embodiments of the present disclosure.

In the COB light of the related art, the LED designs are often set to handle at least 2 A, which is a direct result of the 36 volt operation spec. These individual LEDs have higher girth to them to handle this high current. Because the size of the COB light substrate is limited (e.g., the COB may have a 9 mm, 12 mm, 19 mm, or 24 mm round aperture), the LED size, which is dictated by the current driving therethrough, limits the number of LEDs that may be utilized in a COB light.

Thus, in some embodiments, the current driving each LED is significantly reduced (e.g., about 15 mA to about 45 mA), which allows for a reduction in size (e.g., the cross-sectional area) of the LED and results in high number of LEDs that may fit within the standardized dimensions of the COB light (and thus a higher stack voltage). In some examples, the LEDs may be shrunk by 8% resulting in more series-connected LEDs and thus a step up in the stack voltage to the target zone of about 450 V. Such an emitter size reduction may result in the LPW of the core LED increasing to 205 (e.g., from 140 LPW) and the LPW of the light engine to increase to 195. However, embodiments of the present disclosure are not limited thereto, and significantly greater reduction may be made to the LED size. The increase in number of LEDs may compensate for the loss of lumens resulting from the lower drive current. Thus, the COB light according to some embodiments, may be able to improve LPW, as compared to designs of the related art, while maintaining a high light intensity.

An important consideration when designing the COB light is the presence of high voltage differentials. For example, when a plurality of LED column are present (as, e.g., shown in FIG. 2A), the voltage drop across each column is the total drive voltage divided by the number of LED columns. As such, the voltage differential between LED A1 and B1 may not be high enough to result in arcing. However, in embodiments in which only a few (e.g., only two) LED columns are present on the COB, the voltage differential between A1 and B1 could be significant if a sufficiently high drive voltage is applied and could result in arcing if the LEDs are strung together consecutively in the manner shown in FIG. 2A (i.e., A1→A2→ . . . An→B→ . . . Bn). As a result, in some embodiments, when only a few (e.g., two) LED columns are present, a zigzag connection pattern may be employed as shown in FIG. 2B. In such a configuration, A1 is connected in series with B1, which is connected to A2, and A2 is connected in series with B2, and so on. In other words, in the zigzag configuration, the serial connection may be described as A1→B1→A2→B2→ . . . A→Bn. This ensures that only a small amount of differential voltage exists across each LED (even across columns) and prevents arcing even in the presence of high drive voltages (e.g., 360 V or 450 V).

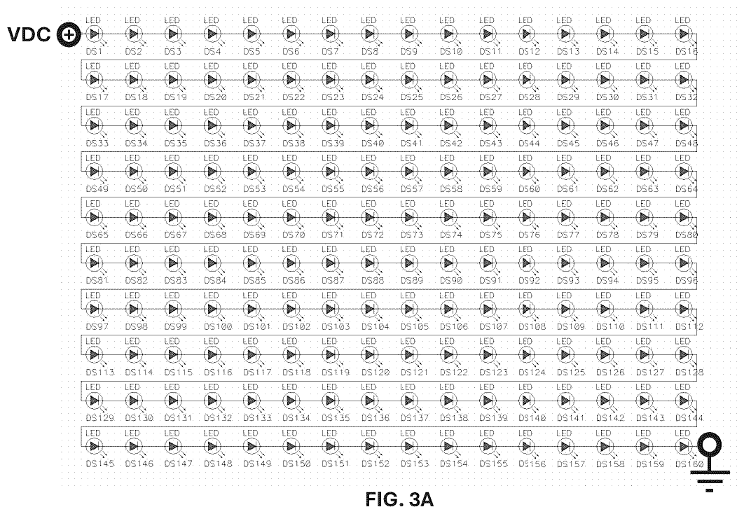

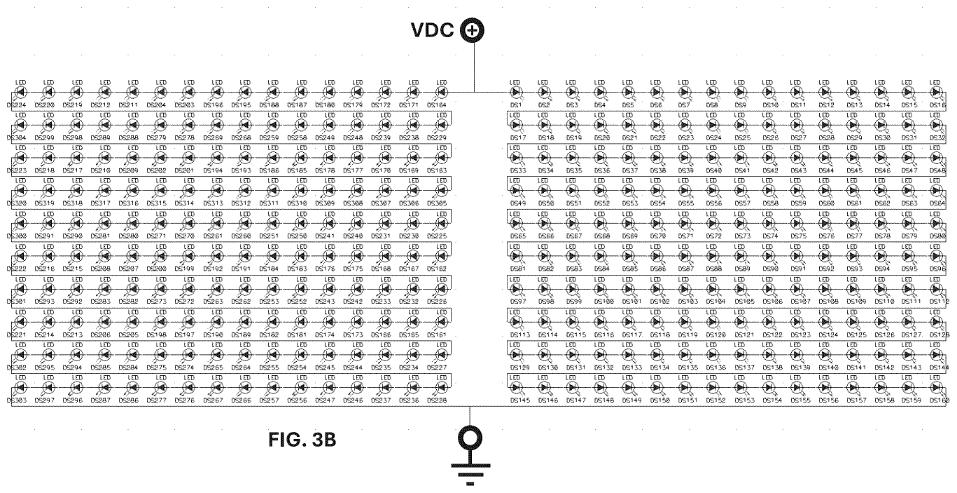

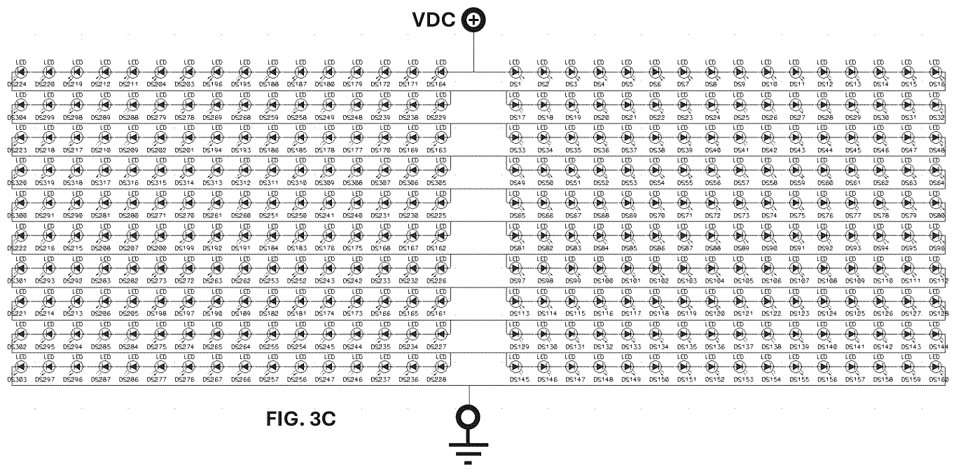

FIG. 3A illustrates an example single-stack configuration of the high-efficiency COB utilizing 160 LED chips that corresponds to the configuration of FIG. 2A. In this dense configuration in which 18×18 mm LED chips are used, the stack voltage may be in the range of 100V to 200V, or higher.

FIG. 3B illustrates an example two-stack configuration of the high-efficiency COB utilizing 320 LED chips, according to some embodiments of the present disclosure. Here, two of the stacks shown in FIG. 3A may be coupled in series between the first power terminal VDC and the second power terminal GND of the COB light.

Such an arrangement requires careful matching of the LED chips in the two stacks to ensure equal current sharing between the two stacks. For example, if the forward voltage of LED chips making up the right stack adds up to a voltage of about 464V, and the forward voltage of the LED chips making up the left stack adds up to a voltage of 474V, the right stack may draw more current than the left stack. This problem may be ameliorated by adding links between the right and left stacks at set intervals, which leads to parallelizing smaller groups of LED chips instead of the full stack. This allows the random variations in the LED chips to better balance out, ensuring a more even sharing of current. That is, instead of an entire stack of a hundred or more LED chips suffering higher current draw due to a few of its LEDs having a low forward voltage, only a small group of LEDs suffer when adding additional parallel links. The smaller the groups, the closer one can get to the ideal, which would be parallel links for every LED. An example of the configuration using parallelizing links is shown in FIG. 3C.

The right stack LEDs will also get hotter from drawing more current, thus lowering their voltage even more, yielding more current drawn. Potentially causing thermal run away.

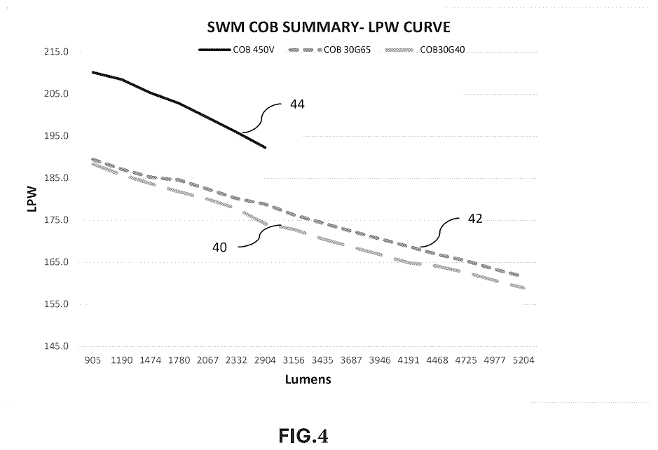

FIG. 4 is a graph illustrating the LPW efficiency of the light engine according to some embodiments relative to that of the lighting systems of the related art.

As shown in FIG. 3, reducing the lumens output of the COB light improves the LPW. In FIG. 3, the curves 40 and 42 illustrate the performance of COB lighting systems of the related art, which operate at 30 V and 0.5 A. As shown, by reducing the size and increasing the number of light emitters on the COB light and connecting the light emitters in series and driving them with low current (e.g., 15 mA) and at high voltages (e.g., 460 V) according to some embodiments, a significantly greater LPW may be achieved at a given lumen output. In other words, the light engine of the present invention, which incorporates the high-LPW-efficiency COB light can achieve reduced power consumption for a given light output, which can reduce the operational costs of the high-efficiency light engine.

A key aspect of the present invention is that the light engine 100 is a safe and an approved fire enclosure certified for running a high voltage stack. Thus, the user is protected by the fact that the engine is fully enclosed and impact tested by UL.

The high stack voltages provided by the light engine is determined by the light driver topology. The light driver topology of choice depends on size of the COB light.

In the example of a small COB, the stack voltage can only be so high due the limited number of LEDs that can fit on such a COB. When the stack voltage is below the rectified line input voltage (which may be about 110 VAC, 270 VAC, etc.), the light driver 100 may utilize a buck-boost topology. However, embodiments of the present disclosure are not limited thereto, and a flyback, forward, charge pumps (switched capacitors), Zeta, SEPIC, Cuk, or even a buck converter may be utilized. When the stack voltage is at or above the rectified input voltage, the light driver may utilize a boost topology.

To reduce any ripple current in the COB light, which may result in visible flicker, regardless of the PFC stage being a boost, buck boost, flyback, or buck converter, a circuit may be employed to cancel out ripple current into the LED and stabilize light output. As such, in some embodiments, the light driver 110 may utilize a two-stage design.

In some examples, the light driver includes two boost converters. The first boost converter is the PFC stage and the second boost converter boosts the output of the first stage enough to cancel out any line frequency ripple. In effect, the second stage fills in the valleys created in the output of the first PFC stage (because the PFC stage is locked into following the AC input voltage), as the AC input voltage rises and falls. However, embodiments of the present disclosure are not limited thereto, and any suitable second stage design, such as a capacitance multiplier, charge pumps, linear regulators, etc., may be utilized to handle ripple suppression.

Given the high drive voltages of these designs, there may be little to no safety benefit to using an isolated topology for the light driver 100. As such, non-isolated topologies may be employed as they offer the highest efficiencies (of, e.g., about 92% to about 95.5% efficiency) and can further improve the LPW efficiency of the light engine 100. However, isolated topologies may also be employed when there are sensitive controls, or for EMI noise filtering.

It will be understood that, although the terms “first”, “second”, “third”, etc., may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of”, when preceding a list of elements, modify the entire list of elements and do not modify the individual elements of the list. Further, the use of “may” when describing embodiments of the inventive concept refers to “one or more embodiments of the inventive concept”. Also, the term “exemplary” is intended to refer to an example or illustration.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the terms “substantially”, “about”, and similar terms are used as terms of approximation and not as terms of degree, and are intended to account for the inherent variations in measured or calculated values that would be recognized by those of ordinary skill in the art.

As used herein, the terms “use”, “using”, and “used” may be considered synonymous with the terms “utilize”, “utilizing”, and “utilized”, respectively.

The integrated multi-layered lighting system and/or any other relevant devices or components, such as the channel controller, according to some embodiments of the present invention described herein may be implemented by utilizing any suitable hardware, firmware (e.g., an application-specific integrated circuit), software, or a suitable combination of software, firmware, and hardware. For example, the various components of the independent multi-source display device may be formed on one integrated circuit (IC) chip or on separate IC chips. Further, the various components of the LED driver may be implemented on a flexible printed circuit film, a tape carrier package (TCP), a printed circuit board (PCB), or formed on the same substrate. Further, the various components of the LED driver may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer-readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

While this invention has been described in detail with particular references to illustrative embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims and equivalents thereof.

What is claimed is:

1. A high-lumens-per-watt (LPW) efficiency light engine comprising:
a rectifier configured to receive an AC input signal and to generate a rectified signal;
a light driver configured to generate a drive signal based on the rectified signal, the drive signal having a voltage of about 100 V to about 485 V;
a light source comprising a high-voltage chip-on-board (COB) light configured to emit light based on the drive signal, the high-voltage chip-on-board (COB) light comprising a first power terminal, a second power terminal, and a plurality of LED chips coupled between the first and second power terminals, the drive signal being applied across the first and second power terminals; and
a housing configured to encapsulate the power supply, the light driver, and the light source and to provide electromagnetic interference (EMI) shielding of circuitry of the light engine from the outside.

2. The high LPW efficiency light engine of claim 1, wherein the drive signal has a current of about 15 mA to about 45 mA for under-driving the plurality of LED chips.

3. The high LPW efficiency light engine of claim 1, wherein each one of the plurality of LED chips is electrically connected in series with other ones of the plurality of LED chips between the first and second power terminals.

4. The high LPW efficiency light engine of claim 1, wherein the plurality of LED chips comprises LED chip stacks that are electrically coupled in series with one another between the first and second power terminals,
wherein each one of the LED chip stacks comprises a first LED chip string and a second LED chip string, the first and second LED chip strings being connected in parallel, and
wherein each one of the first and LED chip strings comprises a subset of series-connected LED chips.

5. The high LPW efficiency light engine of claim 1, wherein the plurality of LED chips are arranged along columns on a substrate of the high-voltage chip-on-board (COB) light, and
wherein a first column of the LED chips are arranged along a first column and are sequentially connected in series, a first LED chip of the first column of the LED chips being connected to the first power terminal, and a last LED chip of the first column of the LED chips being electrically connected in series with a first LED chip of an adjacent column of LED chips.

6. The high LPW efficiency light engine of claim 1, wherein the plurality of LED chips are arranged along columns on a substrate of the high-voltage chip-on-board (COB) light, and
wherein a first column of the LED chips are arranged along a first column and are sequentially connected in series, and a second column of the LED chips are arranged along a second column and are sequentially connected in series, and
wherein a first LED chip of the first column of the LED chips, a first LED chip of the second column of the LED chips, and the second LED chip of the fist column of the LED chips are sequentially connected in series.

7. The high LPW efficiency light engine of claim 1, wherein a LPW of the high LPW efficiency light engine is about 190 to about 210 for lumens output of about 905 to about 2900.

8. The high LPW efficiency light engine of claim 1, wherein the light driver comprises a boost converter configured to boost the rectified signal to a level of the drive signal.
